(19) United States
(12) Patent Application Publication
(10) Pub. No.: US 2020/0294707 A1
(43) Pub. Date: Sep. 17, 2020

(54) APPARATUS AND METHOD FOR OPERATING A VARIABLE-IMPEDANCE LOAD ON THE PLANAR TRANSFORMER IN HIGH-FREQUENCY MODE II

(71) Applicant: KIEFEL GmbH, Freilassing (DE)

(72) Inventor: Christoph Bromberger, Freilassing (DE)

(21) Appl. No.: 16/753,166

(22) PCT Filed: Jul. 22, 2019
(86) PCT No.: PCT/DE2019/000191

§ 371 Date: Apr. 2, 2020

(30) Foreign Application Priority Data
Jul. 22, 2018 (DE) 10 2018 005 738.1
Nov. 22, 2018 (DE) 10 2018 009 166.0

(51) Int. Cl. H01F 27/28

(52) U.S. Cl. CPC H01F 27/28

(57) ABSTRACT

This invention relates to a method for operating a variable impedance load on a device consisting of a planar transformer, consisting of at least a primary and a secondary side, which can be operated as input or output side, comprising primary and secondary coils, wherein capacitances between windings of a coil form a resonant circuit with inductances of the coil. This coil comprises a selection of a resonance frequency of the resonant circuit, wherein the resonance frequency falls on a frequency of a harmonic of an input signal to be suppressed.

The invention relates to a device and a method for operating a variable impedance load on a planar transformer in radio-frequency operation.

### PRIOR ART

Arrangements are disclosed in the prior art in which a source of a signal is connected to a load by means of a transmission path. In the high power range, a low-impedance source (e.g. 1Ω) is typically connected to a low-impedance load that is often variable in impedance (e.g. variable around a value of 1Ω) using a higher-impedance transmission path (e.g. 50Ω). For impedance matching, a first matching network with a (for example fixed) first impedance ratio is usually used between source and transmission path, and a second matching network with a (for example variable) second impedance ratio is used between transmission path and load. The signal is transmitted from the source to the load via the first matching network, transmission path and second matching network. The signal typically has components at a fundamental frequency and components at harmonics, that is to say integer multiples of the fundamental frequency.

The prior art knows transformers as matching networks with a fixed impedance ratio. Transformers have an input coil (“primary winding”) with a first number of windings and an output coil (“secondary winding”) with a second number of windings, as well as a ratio, called the winding ratio, between the second number of windings and the first number of windings.

In the case of low-frequency signals, a transformer with a winding ratio N transforms the voltage between input and output down by a factor N but in contrast transforms the current upwards by a factor N, so that a ratio of source to load impedance of N² can be adjusted using the transformer.

Planar transformers are a special implementation of transformers. A planar transformer has a primary coil and a secondary coil, which primary and secondary coils are essentially planar and plane-parallel, separated by a dielectric.

In terms of radio-frequency technology, planar transformers are components by means of which a signal is transmitted from an input to an output using distributed inductances and distributed capacitances, with a desired change in the signal impedance. While this change in the low-frequency range is between two real impedances in the ratio of the square of the winding ratio, the relationship is more complicated for essentially non-real radio-frequency impedances and for essentially distributed capacitance and inductance coatings in the higher-frequency range.

According to the prior art, it is known to construct the primary coil with mirror symmetry (“primary-side symmetrical planar transformer”). It is also accessible to the prior art, in the case of an even number of windings of the secondary coil, to arrange half of the windings of the secondary coil in a first winding sense above the primary coil, viewed from a first angle of view of the planar transformer, which is suitable for assessing the winding sense and to arrange the other half of the windings below the primary coil in the opposite winding sense (“secondary-side symmetrical planar transformer”), viewed from the first angle of view, which first and second half of the windings are electrically conductively connected to each other in the area of the center of rotation of the windings. Finally, according to the prior art, a planar transformer can be constructed fully symmetrically, that is to say symmetrically on the primary side and on the secondary side.

If the source is a differential amplifier arrangement, in the case of a planar transformer which is symmetrical on the primary side, there is a point in the middle of the primary winding which is connected to ground in terms of radio-frequency technology and via which a supply voltage can be supplied, with only minimal requirements for blocking the output signal from the voltage supply. In the case of a planar transformer which is symmetrical on the secondary side, in the same way there is a point in the middle of the secondary coil which is connected to ground in terms of radio-frequency technology; according to prior art, this is used, for example, to apply a DC voltage to an antenna connection or to tap it from an antenna connection.

Harmonic matching structures are also known in the prior art as the first matching networks, by means of which, depending on the amount and phase, desired values of load impedances for the fundamental wave and for the harmonics can be achieved. A control of the impedances also in the case of the harmonics can be used advantageously in order to achieve time profiles of current and voltage at the output of a source, by means of which a particularly efficient operation of the source is achieved.

A load with a variable impedance typically exhibits a variance in the input impedance not only for the fundamental wave, but also for the harmonics of the signal. The second matching network with a variable impedance ratio according to the prior art is typically only suitable for absorbing the variation in the load impedance at the fundamental frequency of the signal, but it usually does not allow any impedance matching for the harmonics.

A harmonic matching structure as the first matching network is then concluded without further measures on a side facing the transmission path at the fundamental frequency with a defined impedance; at multiples of the fundamental frequency, however, there are variable impedances. Such variable harmonic terminations have a disadvantageous influence on the time profiles of current and voltage at the output of the source.

In order to achieve a reproducible harmonic termination at the source even with variable loads, it is known according to the prior art to design the arrangement consisting of a second matching network, transmission path and first matching network to be impermeable to harmonic frequencies: As a result, reproducible impedance ratios can be achieved at the output of the active components of the amplifier arrangement, and thereby a high efficiency of the source, which is largely independent of the impedance of the load.

In particular, the prior art knows structures, for example frequency-selective suction circuits or crossovers, by means of which the harmonics are deviated to ground. Such a deviation to ground represents, for example, a short circuit in the respective harmonic and offers a defined impedance in the respective harmonic; based on this, the first matching network can be designed so that the source can always be operated with high efficiency.

A disadvantage of the prior art is in particular that such measures for deviating the harmonics are associated with a high outlay. Another disadvantage of the prior art is that such measures for deviating the harmonics always involve a loss of signal power, which reduces the overall efficiency.

The aim of a development would therefore be to provide measures by means of which, while reducing the disadvantages of the prior art, with harmonious matching, a consistently high efficiency of a source can be achieved even if the source is operated to drive a variable impedance load.

It is therefore desirable to provide means that solve the low-loss operation of a variable impedance load without having the disadvantages of the prior art.

The objective of low-loss operation of a variable impedance load without having the disadvantages of the prior art is solved by the invention “frequency-selective non-transparent planar transformer I.” This invention relates to a method for operating a variable impedance load on a device consisting of a planar transformer, consisting of at least a primary and a secondary side, which can be operated as input or output side, comprising primary and secondary coils, wherein capacitances between windings of a coil form a resonant circuit with inductances of the coil. This coil comprises a selection of a resonance frequency of the resonant circuit, wherein the resonance frequency falls on a frequency of a harmonic of an input signal to be suppressed.

A “planar transformer” is a special type of transformer that is characterized by a flat design. In terms of radio-frequency, a planar transformer is a distributed structure with capacitive and inductive components. The inductive components are dominated by the coils; the capacitive components consist on the one hand of the capacitance coating between the primary and secondary coils, and on the other hand of a possible capacitance between two windings within the primary or the secondary coil itself, provided that these consist of (partial) coils with more than one winding.

The capacitance between two windings of a coil of a planar transformer forms a resonant circuit with the inductance of the coil. In the context of the method according to the invention, the resonance frequency of this resonant circuit is selected such that it falls on the frequency of a harmonic of the signal to be suppressed. As a result, in the case of the harmonic to be suppressed, no signal can be transmitted from the output to the input of the planar transformer. On the input side, the planar transformer provides an impedance for the harmonic to be suppressed, which impedance does not depend on a (reflected) signal hitting the output of the planar transformer: The planar transformer is non-transparent for these harmonics, the harmonic termination on the input side is independent of the state of the load and the second matching network.

The radio-frequency planar transformer, with a given number of windings in the secondary coil, can conventionally consist of two layers, wherein a first layer can be the primary side and the other layer, which for illustration is arranged parallel to the first layer, can be the secondary side. The planar transformer can also have more than just one primary or secondary layer, in various combinations. For example, the planar transformer according to the invention can have a primary side (here: “side” has the same meaning as “layer” or “coil”), which, as in a sandwich arrangement, is arranged in the middle between two secondary sides (here: “side” has the same meaning as “layers,” “halves,” “coils”). Half of the windings of the secondary coil are above, the other half below the primary coil. In the middle there is a ‘virtual ground.’ When viewed from above, both halves appear in two opposite winding senses; this must be so because in one half the current flows “from the inside out” and the other half “from the outside in,” but the (partial) voltages that are induced in both halves should add up, instead of canceling each other out.

A further embodiment of the planar transformer for carrying out the method according to the invention can be made from a stepwise parallel connection of primary and secondary coils. For example, an arrangement can have three primary coils and four secondary coils. These can be arranged alternately: Secondary coil, primary coil, secondary coil, primary coil, secondary coil, primary coil, secondary coil. The primary coils are all connected in parallel, which means that they represent a single coil with a single winding, only that this winding consists of three parallel “wires.” Two adjacent pairs of the secondary coils (the two upper and the two lower coils) are connected in parallel as a pair.

Another embodiment of a planar transformer, which embodiment is advantageously suitable for implementing the method according to the invention, has more than one primary coil.

In a further embodiment of a planar transformer, which embodiment is advantageously suitable for implementing the method according to the invention, at least some of the primary coils are electrically connected in parallel with one another.

Another embodiment of a planar transformer, which embodiment is advantageously suitable for implementing the method according to the invention, has more than one secondary coil.

In a further embodiment of a planar transformer, which is advantageously suitable as an embodiment for implementing the method according to the invention, at least some of the secondary coils are electrically connected in parallel with one another.

A planar transformer, which extends over seven layers which are essentially plane-parallel to one another, serves as an illustrative example; in a row of successive layers perpendicular to the layers referred to as first layer S1, second layer P1, third layer S2, fourth layer P2, fifth layer S3, sixth layer P3 and seventh layer S4.

Three, for example geometrically congruent, primary coils each with a first and a second input are arranged in the second layer P1, the fourth layer P2 and the sixth layer P3, wherein the first inputs of all primary coils are electrically short-circuited with each other, and the second inputs of all primary coils are electrically short-circuited with each other. A first secondary coil consists of a first coil section T1 with a first number of windings of a first winding sense in the first layer S1 and a fourth coil section T4 of the first number of windings of the winding sense opposite to the first winding sense in the seventh layer S4; a second secondary coil consists of a second coil section T2 of the first number of windings of the first winding sense in the third layer S2 and of a third coil section T3 of the first number of windings of the winding sense opposite to the first winding sense in the fifth layer S3; viewed in the direction of rotation of the windings, the inner ends of the first coil section T1, the second coil section T2, the third coil section T3 and the fourth coil section T4 are connected to one another in an electrically conductive manner; ends of the first coil section T1 and the second coil section T2, which lie outside when viewed in the direction of rotation of the windings, are connected to one another in an electrically conductive manner; ends of the third coil section T3 and the fourth coil section T4, which lie outside when viewed in the direction of rotation of the windings, are connected to one another in an electrically conductive manner.

The method according to the invention can provide an impedance on the input side of the planar transformer, which does not depend on a signal reflected at the output, so that the planar transformer appears non-transparent for the harmonic.

To solve the objective problem, a method for operating a planar transformer, consisting of a primary and a secondary side, wherein that primary side has at least a first coil and that secondary side has at least a second coil, can be provided. The second coil is constructed symmetrically and has a point of symmetry and a differential output with two branches. This second coil between the point of symmetry and a first branch of the differential output has a distributed inductance and a distributed capacitance between its windings and can further comprise the feature that a resonance frequency between the distributed inductance and the distributed capacitance is selected equal to a multiple of a preferred operating frequency.

The object can also be achieved by a method for operating a planar transformer, which has a preferred operating frequency and consists of a primary and a secondary side. The primary side has an input with a first input impedance at the preferred operating frequency and the secondary side has an output with a first output impedance at the preferred operating frequency, with a first source impedance and a first load impedance. At the preferred operating frequency, the first source impedance is the complex conjugate of the first load impedance of the input impedance when the output is terminated. And the first load impedance is the complex conjugate of the first source impedance of the output impedance when the input is terminated. The primary side has at least a first coil and that secondary side has at least a second coil, which second coil is constructed symmetrically. In the case of differential operation of the planar transformer, a virtual radio-frequency ground is thus shown at the point of symmetry, which comprises selecting a resonance frequency between distributed inductance and distributed capacitance equal to a multiple of a preferred operating frequency.

The planar transformers according to the invention with the method according to the invention can be operated in radio-frequency operation. While this change in the low-frequency range is between two real impedances in the ratio of the square of the winding ratio, the relationship is more complicated for essentially non-real radio-frequency impedances and for essentially distributed capacitance and inductance coatings in the higher-frequency range. The radio-frequency operation can be f≥10 MHz. Furthermore, the radio-frequency operation can be 50 kHz≤f≤10 MHz.

An embodiment of the device according to the invention can comprise a planar transformer, having at least a primary and a secondary side, which can be operated as input or output side, and comprise a controller, wherein the controller has a programming which comprises the steps according to one of the preceding method steps.

Another embodiment of the device according to the invention can comprise a planar transformer, which has a preferred operating frequency and consists of a primary and a secondary side, wherein that primary side has at least a first coil and that secondary side has at least a second coil, which second coil being constructed symmetrically and having a point of symmetry and a differential output with two branches, which second coil having between the point of symmetry and a first branch of the differential output a distributed inductance and a distributed capacitance between its windings, characterized in that a resonance frequency between the distributed inductance and distributed capacitance is equal to a multiple of the preferred operating frequency.

The device according to the invention can further comprise a planar transformer, which has a preferred operating frequency and consists of a primary and a secondary side, the primary side of which has an input with a first input impedance at the preferred operating frequency and which secondary side has an output with a first output impedance at the preferred operating frequency with a first source impedance and a first load impedance, wherein at the preferred operating frequency the first source impedance is the complex conjugate of the first load impedance of the input impedance, when the output is terminated, and the first load impedance is the complex conjugate of the first source impedance of the output impedance, when the input is terminated, wherein that primary side has at least a first coil and that secondary side has at least a second coil, which second coil is constructed symmetrically and has a virtual radio-frequency ground at the point of symmetry, when the planar transformer is operating in differential mode, which is characterized in that a resonance frequency between distributed inductance and distributed capacitance is equal to a multiple of the preferred operating frequency.

The device according to the invention and the method according to the invention can also be combined with further, optional advantageous features. For illustration, it is pointed out again that it is an object of the invention to achieve a high efficiency with a variable impedance load in the radio-frequency range. The above-mentioned methods, devices and their embodiments relate to the use of the capacitances within a coil (for example the secondary coil/s) in order to ensure efficiency. Other embodiments may combine use of these and use of capacitances between primary and secondary coils to achieve increased efficiency.

In the combined embodiment, the inductance coating along the coils forms, together with the capacitance coating between the primary and secondary coils, a strip line with a given line impedance and a given electrical line length. The electrical line length in turn depends on the geometric length of the line and on the speed of propagation of the signal in the dielectric.

At a signal frequency, a virtual RF ground is mapped to a first impedance at the point of symmetry of the secondary coil. If the electrical length of the path from the point of symmetry along the secondary coil to the output of the secondary coil is selected to be equal to an odd (even) multiple of a quarter of the wavelength of a desired harmonic, the transmission of a signal from the output to the input of the fully symmetrical planar transformer has a maximum loss if this output is terminated with an open circuit (short circuit). For all load impedances normally to be expected at the output of the planar transformer, which is terminated with the transmission path, second matching network and load, the transmission from the output to the input is low—the planar transformer therefore provides an impedance on the input side at the desired harmonic, which impedance does not depend on a (“reflected”) signal hitting the output of the planar transformer: The planar transformer is non-transparent for these harmonics, the harmonic termination on the input side is independent of the state of the load and the second matching network.

A transistor with a relatively high output power and at the same time a relatively low operating voltage delivers its output power particularly efficiently to a low-resistance load: A modern LDMOS with 130 V breakdown voltage is typically operated with 50 V supply voltage. When fully controlled, the radio-frequency output voltage swings by +/−50 V around 50 V. In order to take 1 kW output power from the transistor, 40A output current is required, the output impedance is 50 V/40 A, i.e. in the region of 1 ohm: This is only determined by the operating voltage and output power, so a load impedance of around 1 ohm is absolutely necessary here.

In order to be able to supply the typically 50 ohms of a “real” load with this transistor, a matching network is required that maps 50 ohms to 1 ohm. A planar transformer according to the invention can be part of this matching network.

The efficiency of the amplifier, i.e. the combination of transistor and matching network, is determined both by the efficiency with which the transistor is operated and by the losses in the matching network, especially in the planar transformer. The losses in the matching network are also influenced by the impedance with which the matching network is terminated on the input and output side. If, for example, the primary coil is driven by a push-pull amplifier, the differential output impedance of the push-pull amplifier can be seen at the input as the termination of the primary coil. In contrast, 50 ohms are present at the output of the secondary coil, for example.

The ‘windings ratio’ is the number of windings of the secondary coil divided by the number of windings of the primary coil. If a source with a very high source power (e.g. 2500 W from 36 V), based on the operating voltage of the source, is to be operated with a moderate load impedance (e.g. 50 ohms), a planar transformer with a winding ratio significantly greater than one appears to be advantageous for matching. For example, a planar transformer can be selected with one winding in the primary coil and three windings in the secondary coil each above and below the primary coil. It can be seen that such planar transformers with a high winding ratio have a minimum loss when terminating on the output and input side, each with impedances that are unfavorably high for the operation of the source or the matching of the load, but disadvantageously high losses when terminating with the existing load and source impedances.

The load impedance by which the losses in the matching network are minimized depends on the line impedance of the “line” secondary coil, with the primary coil as reference ground. This line impedance is reduced according to the invention by connecting two halves of the secondary coil in parallel here. The advantage: the inductance coating decreases (two coils in parallel), the capacitance coating increases, the line impedance as the square root of the inductance coating divided by the capacitance coating decreases by half with two parallel secondary coils.

In the last-mentioned embodiment (parallel connection) of the planar transformer, for example, the spaces between the first layer S1 and the second layer P1, the second layer P1 and the third layer S2, the third layer S2 and the fourth layer P2, the fourth layer P2 and the fifth layer S3, the fifth layer S3 and the sixth layer P3, the sixth layer P3 and the seventh layer S4 are each filled with the same dielectric, a first distance between the second layer P1 and the third layer S2, between the third layer S2 and the fourth layer P2, between the fourth layer P2 and the fifth layer S3 and between the fifth layer S3 and the sixth layer P3 twice as large as a second distance between the first layer S1 and the second layer P1 and between the sixth layer P3 and the seventh layer S4 can be selected. As a result, all windings of the secondary coil are provided with similar line impedances.

The device according to the invention can therefore map both the correct ratio of input to output impedance, for example 50 ohms, to a suitable load impedance for the transistor, and at the same time offer low losses at precisely these 50 ohms as load impedance.

The method according to the invention can therefore be combined with a method for operating a variable impedance load on a device, consisting of a planar transformer, consisting of at least a primary and a secondary side, which can be operated as an input or output side, comprising a virtual image RF ground at the point of symmetry of one of the secondary sides to a first impedance.

The above combined method can further comprise selecting a route to a point of symmetry along one of the secondary sides to the output of the secondary side equal to an odd (or even) multiple of a quarter of a wavelength of a desired harmonic; and/or terminating the output of the secondary side with an open circuit (or short circuit).

Another possible combination is the addition of a method for operating a planar transformer consisting of a primary and a secondary side, wherein that primary side has at least a first coil and that secondary side has at least a second coil, which second coil is constructed symmetrically and has a point of symmetry and a differential output with two branches, which second coil between the point of symmetry and a first branch of the differential output has a distributed inductance and a distributed capacitance to the first coil, which comprises a selection of a resonance frequency between distributed inductance and distributed capacitance, which is equal to a multiple of a preferred operating frequency.

Likewise, the method according to the invention can be carried out with a method for operating a planar transformer consisting of a primary and a secondary side, wherein that primary side has at least a first coil and that secondary side has at least a second coil, which second coil is constructed symmetrically and, when the planar transformer is operating in differential mode, has a virtual radio-frequency ground at the point of symmetry, which comprises selecting an electrical length of the secondary coil smaller than half the wavelength at a preferred operating frequency and equal to an integral multiple of an integer fraction of half the wavelength at the preferred operating frequency.

In another embodiment, the method according to the invention can include a method for operating a planar transformer. This has a preferred operating frequency and consists of a primary and a secondary side, which primary side has an input with a first input impedance at the preferred operating frequency and which secondary side has an output with a first output impedance at the preferred operating frequency, with a first source impedance and a first load impedance, wherein at the preferred operating frequency the first source impedance is the complex conjugate of the first load impedance of the input impedance, when the output is terminated, and the first load impedance is the complex conjugate of the first source impedance of the output impedance, when the input is terminated, wherein that primary side has at least a first coil and that secondary side has at least a second coil, which second coil is constructed symmetrically and has a virtual radio-frequency ground at the point of symmetry when the planar transformer is operating in differential mode, which comprises selecting an electrical length of the secondary coil, which is less than half the wavelength at the operating frequency and is an integer multiple of an integral fraction of half the wavelength at the operating frequency.

One embodiment of a device which can use the above-mentioned methods to achieve the object according to the invention is a planar transformer, which has at least a primary and a secondary side, which can be operated as input or output side, and a controller, wherein the controller comprises a programming which comprises the steps according to one of the preceding claims.

Furthermore, a planar transformer, as a device according to the invention, can have a preferred operating frequency and consist of a primary and a secondary side, wherein that primary side has at least a first coil and that secondary side has at least a second coil, which second coil is constructed symmetrically and with differential operation of the planar transformer has a virtual radio-frequency ground at the point of symmetry. This embodiment is characterized in that an electrical length of the secondary coil is less than half the wavelength at the operating frequency and is equal to an integer multiple of an integer fraction of half the wavelength at the operating frequency.

Another embodiment of the device is a planar transformer, which has a preferred operating frequency and consists of a primary and a secondary side, wherein that primary side has at least a first coil and that secondary side has at least a second coil, which second coil is constructed symmetrically and has a point of symmetry and a differential output with two branches, which second coil has a distributed inductance and a distributed capacitance to the first coil between the point of symmetry and a first branch of the differential output. This embodiment is characterized in that a resonance frequency between the distributed inductance and the distributed capacitance is equal to a multiple of the preferred operating frequency and thus the efficiency is optimized.

Another embodiment of a device for applying the method according to the invention is a planar transformer which has a preferred operating frequency and consists of a primary and a secondary side, which primary side has an input with a first input impedance at the preferred operating frequency and which secondary side has an output with a first output impedance at the preferred operating frequency. This has a first source impedance and a first load impedance, wherein in the case of the preferred operating frequency the first source impedance is the complex conjugate of the first load impedance of the input impedance, when the output is terminated, and the first load impedance is the complex conjugate of the first source impedance of the output impedance, when the input is terminated, wherein that primary side has at least a first coil and that secondary side has at least a second coil, which second coil is constructed symmetrically and has a virtual radio-frequency ground at the point of symmetry when the planar transformer is operating in differential mode. The device is further characterized in that an electrical length of the secondary coil is less than half the wavelength at the operating frequency and equal to an integer multiple of an integer fraction of half the wavelength at the operating frequency.

The above-mentioned embodiments regarding the devices can furthermore have a controller, wherein the controller has a programming which has the steps according to one of the preceding claims.

Deviating from the structure described above, due to the greatest possible simplicity of presentation, a user skilled in art can also apply the teaching disclosed in the present invention in such a way that the radio-frequency ground, which is located in the structure described so far in a point of symmetry of the secondary coil, lies in another point, for example, when a first number of windings of a first winding sense are arranged in a first layer of the secondary coil and a second number of windings of a winding sense opposite to the first winding sense, which number of windings are different from the first number, are arranged in a second layer of the secondary coil.

It should be expressly pointed out that these combinations of features can be combined with the combinations of features from the patent claims.

### BRIEF DESCRIPTION OF THE FIGURES

FIG. 1 device according to the invention—a planar transformer

### DETAILED DESCRIPTION OF THE FIGURES

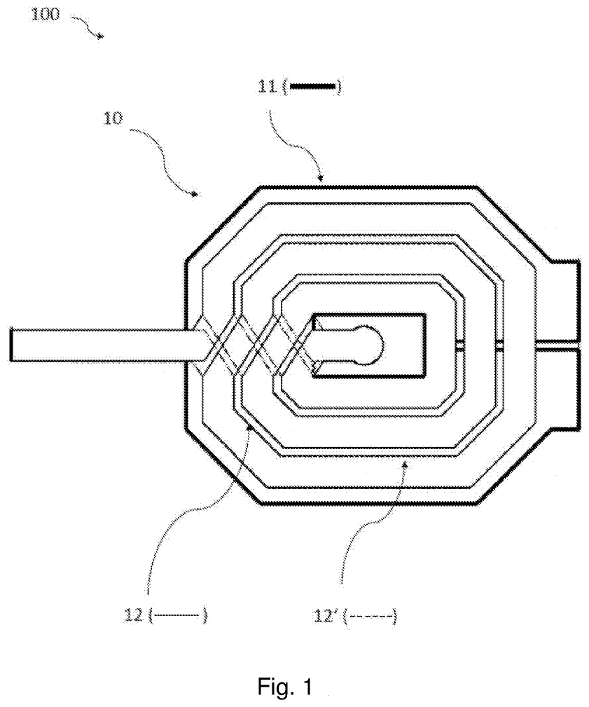

FIG. 1 shows a device according to the invention, which can carry out a method 100 according to the invention. The device 10 consists of a planar transformer 10. The radio-frequency planar transformer 10, with a variable number of windings in the secondary coil, can conventionally consist of two layers, wherein a first layer can be the primary side and the other layer, which for illustration is arranged parallel to the first layer, can be the secondary side. The planar transformer in FIG. 1 has more than just a secondary coil. The planar transformer in FIG. 1 according to the invention contains a primary side 11 (thick outer line) which, as in a sandwich arrangement, is arranged centrally between two secondary sides 12, 12′ (thin line, thin dashed line). Half of the windings of the secondary coil 12 are above, the other half 12′ below the primary coil 11. The two secondary coils 12, 12′ have winding directions which are opposite to each other. In the middle, where the windings of the secondary coils are also linked, there is a ‘virtual ground’ . When viewed from above, both halves appear to have winding senses which are opposite to each other; this must be so because in one half the current flows “from the inside out” and the other half “from the outside in,” but the (partial) voltages that are induced in both halves should add up instead of canceling each other out.

### LIST OF THE REFERENCE SYMBOLS USED

10 device according to the invention—planar transformer
11 primary coil of the planar transformer
12 a secondary coil of the planar transformer (above)
12′ symmetrical secondary coil of the planar transformer (below)
100 method according to the invention

1. A method for operating a variable impedance load on a planar transformer, consisting of at least a primary and a secondary side, which can be operated as an input or output side, comprising primary and secondary coils, wherein capacitances between windings of a coil form a resonant circuit with inductances of the coil, comprising:
the selection of a resonance frequency of the resonant circuit, wherein the resonance frequency falls on a frequency of a harmonic of an input signal to be suppressed.

2. The method of claim 1, further comprising providing an impedance on the input side of the planar transformer, which does not depend on a signal reflected at the output, so that the planar transformer appears non-transparent for the harmonic.

3. The method for operating a planar transformer, consisting of a primary and a secondary side, wherein that primary side has at least a first coil and that secondary side has at least a second coil, which second coil is constructed symmetrically and has a point of symmetry and a differential output with two branches, which second coil between the point of symmetry and a first branch of the differential output has a distributed inductance and a distributed capacitance between its windings, comprising:
Selecting a resonance frequency between distributed inductance and distributed capacitance equal to a multiple of a preferred operating frequency.

4. The method for operating a planar transformer, having a preferred operating frequency and consisting of a primary and a secondary side, which primary side has an input with a first input impedance at the preferred operating frequency and which secondary side has an output with a first output impedance at the preferred operating frequency, with a first source impedance and a first load impedance, wherein at the preferred operating frequency the first source impedance is the complex conjugate of the first load impedance of the input impedance, when the output is terminated, and the first load impedance is the complex conjugate of the first source impedance of the output impedance, when the input is terminated, wherein that primary side has at least a first coil and that secondary side has at least a second coil, which second coil is constructed symmetrically and has a virtual radio-frequency ground at the point of symmetry, when the planar transformer is operating in differential mode, comprising:
Selecting a resonance frequency between distributed inductance and distributed capacitance equal to a multiple of a preferred operating frequency.

5. The method according to claim 1, characterized in that the planar transformer is operating in radio-frequency operation.

6. The method according to claim 5, characterized in that the radio-frequency operation is f≥10 MHz.

7. The method according to claim 5, characterized in that the radio-frequency operation is 50 kHz≤f≤10 MHz.

8. Planar transformer, having at least a primary and a secondary side, which can be operated as an input or output side, and a controller, wherein the controller has a programming which has the steps according to claim 1.

9. Planar transformer, having a preferred operating frequency and consisting of a primary and a secondary side, wherein that primary side has at least a first coil and that secondary side has at least a second coil, which second coil is constructed symmetrically and has a point of symmetry and a differential output with two branches, which second coil between the point of symmetry and a first branch of the differential output has a distributed inductance and a distributed capacitance between its windings, characterized in that a resonance frequency between the distributed inductance and the distributed capacitance is equal to a multiple of the preferred operating frequency.

10. Planar transformer, having a preferred operating frequency and consisting of a primary and a secondary side, which primary side has an input with a first input impedance at the preferred operating frequency and which secondary side has an output with a first output impedance at the preferred operating frequency, with a first source impedance and a first load impedance, wherein at the preferred operating frequency the first source impedance is the complex conjugate of the first load impedance of the input impedance, when the output is terminated, and the first load impedance is the complex conjugate of the first source impedance of the output impedance, when the input is terminated, wherein that primary side has at least a first coil and that secondary side has at least a second coil, which second coil is constructed symmetrically and has a virtual radio-frequency ground at the point of symmetry when the planar transformer is operating in differential mode, characterized in that a resonance frequency between distributed inductance and distributed capacitance is equal to a multiple of the preferred operating frequency.

11. The method according to claim 2, characterized in that the planar transformer is operating in radio-frequency operation.

12. The method according to claim 3, characterized in that the planar transformer is operating in radio-frequency operation.

13. The method according to claim 4, characterized in that the planar transformer is operating in radio-frequency operation.

14. Planar transformer, having at least a primary and a secondary side, which can be operated as an input or output side, and a controller, wherein the controller has a programming which has the steps according to claim 2.

15. Planar transformer, having at least a primary and a secondary side, which can be operated as an input or output side, and a controller, wherein the controller has a programming which has the steps according to claim 3.

16. Planar transformer, having at least a primary and a secondary side, which can be operated as an input or output side, and a controller, wherein the controller has a programming which has the steps according to claim 4.

17. Planar transformer, having at least a primary and a secondary side, which can be operated as an input or output side, and a controller, wherein the controller has a programming which has the steps according to claim 5.

18. Planar transformer, having at least a primary and a secondary side, which can be operated as an input or output side, and a controller, wherein the controller has a programming which has the steps according to claim 6.

19. Planar transformer, having at least a primary and a secondary side, which can be operated as an input or output side, and a controller, wherein the controller has a programming which has the steps according to claim 7.
